(19) United States
(12) Patent Application Publication
(10) Pub. No.: US 2024/0352184 A1
(43) Pub. Date: Oct. 24, 2024

(54) Poly(Glycolic Acid)-Containing Resin Composition and Film Including the Same

(71) Applicant: SK Innovation Co., Ltd., Seoul (KR)

(72) Inventors: Sang Yeup Lee, Daejeon (KR); Do Young Kim, Daejeon (KR)

(21) Appl. No.: 18/601,180

(22) Filed: Mar. 11, 2024

(30) Foreign Application Priority Data
Apr. 18, 2023 (KR) 10-2023-0050529

(51) Int. Cl. C08G 63/06; C08J 5/18

(52) U.S. Cl. CPC C08G 63/06; C08J 5/18; C08J 2367/04

(57) ABSTRACT

A poly(glycolic acid)-containing resin composition includes a poly(glycolic acid), a zinc-containing ionomer (Zn ionomer), and an ethylene-based terpolymer. A film including the poly(glycolic acid)-containing resin composition is also provided. The poly(glycolic acid)-containing resin composition and the film can be widely applied in the field of green technologies, such as a biodegradable resin, a biodegradable food packaging film, a biodegradable sanitary product, and other biodegradable plastics.

### CROSS-REFERENCE TO RELATED APPLICATION

This application claims priority to Korean Patent Application No. 10-2023-0050529 filed Apr. 18, 2023, the disclosure of which is hereby incorporated by reference in its entirety.

### BACKGROUND OF THE INVENTION

### 1. Field of the Invention

The disclosure of the present application relates to a poly(glycolic acid)-containing resin composition and a film comprising the same.

### 2. Description of Related Art

A biodegradable resin is a resin that can be decomposed by other organic organisms, such as bacteria and microorganisms. As environmental pollution by conventional non-degradable polymers is increasing, demands for the biodegradable resin as a substitute for the non-degradable resin are also increasing. Additionally, the biodegradable resin has recently been used in various industrial fields, such as a packaging industry, an electronic industry, an automobile industry, a building material industry, a marine industry, a stationery industry, a pulp/paper industry, etc. Examples of the biodegradable resins include poly(glycolic acid) (PGA), poly(butylene succinate) (PBS), polyhydroxyalkanoate (PHA), polylactic acid (PLA), etc. PGA may be synthesized by a polymerization of glycolic acid. PGA may have enhanced biodegradability and may have high gas barrier properties by a linear resin structure.

Additionally, the PGA resin has an internal ester bond to provide a high crystallinity, thereby providing improved mechanical strength and high brittleness.

However, the PGA resin has a high melting point and a low melt strength and may be easily decomposed by heat and moisture. Accordingly, a film including the PGA resin may not be easily formed.

### SUMMARY OF THE INVENTION

According to an embodiment of the present invention, there is provided a poly(glycolic acid)-containing resin composition providing improved barrier properties.

According to an embodiment of the present invention, there is provided a film formed from the resin composition and providing improved barrier properties.

A poly(glycolic acid)-containing resin composition comprises a poly(glycolic acid), a zinc-containing ionomer, and an ethylene-based terpolymer.

In some embodiments, the zinc-containing ionomer may comprise a terpolymer of ethylene, zinc (meth)acrylate and (meth)acrylic acid.

In some embodiments, the ethylene-based terpolymer may comprise a copolymer of ethylene, glycidyl methacrylate and an alkyl acrylate.

In some embodiments, a content of the poly(glycolic acid) may be in a range from 60 weight percent (wt. %) to 98 wt. %, based on a total weight of the poly(glycolic acid)-containing resin composition.

In some embodiments, a content of the zinc-containing ionomer may be in a range from 1 wt. % to 39 wt. %, based on a total weight of the poly(glycolic acid)-containing resin composition.

In some embodiments, a content of the ethylene-based terpolymer may be in a range from 1 wt. % to 39 wt. %, based on a total weight of the poly(glycolic acid)-containing resin composition.

In some embodiments, a sum of a content of the zinc-containing ionomer and a content of the ethylene-based terpolymer may be in a range from 2 wt. % to 40 wt. %, based on a total weight of the poly(glycolic acid)-containing resin composition.

In some embodiments, a content of the poly(glycolic acid) may be greater than a sum of a content of the zinc-containing ionomer and a content of the ethylene-based terpolymer, based on a total weight of the poly(glycolic acid)-containing resin composition.

In some embodiments, the poly(glycolic acid)-containing resin composition may have a melt viscosity of 200 Pa·s to 10,000 Pa·s measured under conditions of 230° C., a 5% strain and a frequency of 0.1 Hz.

In some embodiments, the poly(glycolic acid)-containing resin composition may have a melt flow index of 1 g/10 min to 200 g/10 min measured at 230° C. and a load of 2.16 kg.

A film formed from the poly(glycolic acid)-containing resin composition according to the embodiments described herein is provided.

In some embodiments, a thickness of the film may be in a range from of 50 μm to 250 μm.

In some embodiments, an oxygen permeability of the film measured at a relative humidity of 50% and 25° C. may be 200 g/m²·day or less.

In some embodiments, an oxygen permeability of the film may satisfy Formula 1.

$$OTR ( PGA - Poly ) < 0.1 ( x \cdot OTR ( PGA ) + ( 1 - x ) \cdot OTR ( Poly ) ) \qquad [ Formula 1 ]$$

In Formula 1, OTR (PGA-Poly) is an oxygen permeability of the film formed from the poly(glycolic acid)-containing resin composition, OTR (PGA) is an oxygen permeability of a film comprising only poly(glycolic acid), OTR (Poly) is an oxygen permeability of a film comprising a resin that comprises only the zinc-containing ionomer or the ethylene-based ternary copolymer, and x is 0.6≤x<1.

A poly(glycolic acid)-containing resin composition according to embodiments described herein may comprise poly(glycolic acid) (PGA), a Zn ionomer (ZnIO), and an ethylene-based ternary copolymer. Accordingly, the poly(glycolic acid)-containing resin composition may have an increased molecular weight and may have improved impact resistance. Additionally, the polyglycolic acid-containing resin composition may have a low melt flow index to have improved film-forming properties.

The poly(glycolic acid)-containing resin composition may comprise PGA in a predetermined amount. Accordingly, biodegradable and gas barrier properties of a film comprising the poly(glycolic acid)-containing resin composition may be improved, and processability may also be improved.

A film according to embodiments described herein may include the poly(glycolic acid)-containing resin composition. Accordingly, a gas permeation path at an inside of the film may become complex, and a gas permeability may be reduced.

The poly(glycolic acid)-containing resin composition and the film of the present disclosure may be widely applied in the field of green technologies, such as a biodegradable resin, a biodegradable food packaging film, a biodegradable sanitary product, and other biodegradable plastics to which a biodegradable composition may be used. The poly(glycolic acid)-containing resin composition and the film of the present disclosure may suppress earth pollution, water pollution, air pollution, etc., and may be used in eco-friendly materials, such as eco-friendly disposable products.

### BRIEF DESCRIPTION OF THE DRAWING

FIG. 1 is a graph showing measured values of oxygen permeability and estimated values of oxygen permeability of a film in accordance with example embodiments.

### DESCRIPTION OF THE INVENTION

Embodiments of the present invention provide a poly(glycolic acid)-containing resin composition and a film formed from the poly(glycolic acid)-containing resin composition.

Hereinafter, the present invention will be described in detail with reference to the accompanying drawing. However, those skilled in the art will appreciate that such embodiments described with reference to the accompanying drawing are provided to further understand the spirit of the present invention and do not limit subject matters to be protected as disclosed in the detailed description and appended claims.

Furthermore, throughout the disclosure, unless otherwise particularly stated, the word “comprise”, “include”, “contain”, or “have” does not mean the exclusion of any other constituent element, but means further inclusion of other constituent elements, and elements, materials, or processes which are not further listed are not excluded.

Unless the context clearly indicates otherwise, the singular forms of the terms used in the present specification may be interpreted as including the plural forms. As used herein, the singular form of “a”, “an”, and “the” include plural referents unless the context clearly states otherwise.

The numerical range used in the present disclosure comprises all values within the range comprising the lower limit and the upper limit, increments logically derived in a form and spanning in a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present disclosure. Unless otherwise defined in the present disclosure, values which may be outside a numerical range due to experimental error or rounding off of a value are also comprised in the defined numerical range.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Hereinafter, unless otherwise particularly defined in the present disclosure, “about” may be considered as a value within 30%, 25%, 20%, 15%, 10%, 5%, 3%, 2%, 1%, 0.5%, 0.1%, 0.05% or 0.01% of a stated value. Unless indicated to the contrary, the numerical parameters set forth in this disclosure are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used herein, “formed from” or “prepared from” denotes open, e.g., “comprising,” claim language. As such, it is intended that a composition “formed from” or “prepared from” a list of recited components be a composition comprising at least these recited components or the reaction product of at least these recited components, and can further comprise other, non-recited components, during the composition's formation or preparation. As used herein, the phrase “reaction product of” means chemical reaction product(s) of the recited components, and can include partial reaction products as well as fully reacted products.

According to embodiments, the poly(glycolic acid)-containing resin composition may comprise a poly(glycolic acid) (PGA), a Zn-ionomer (ZnIO) and an ethylene-based ternary copolymer.

The PGA is a biodegradable polymer having a linear structure with an ester bond, and may have high biodegradability. Additionally, the PGA may have a high crystallinity by hydrogen bonding between PGA polymers. Accordingly, gas barrier properties of the poly(glycolic acid)-containing resin composition may be improved.

The ZnIO refers to a polymer comprising zinc that is a transition metal, and has low moisture absorbance and moisture content. Additionally, structural stability of the poly(glycolic acid)-containing resin composition may be improved by a coordination bonding with the ester group of the PGA.

The ethylene-based ternary copolymer may be obtained by copolymerizing three basic monomers comprising a monomer derived from ethylene. The ethylene-based ternary copolymer may be cross-linked with the PGA and the ZnIO to improve structural stability.

In some embodiments, the ZnIO may comprise a ternary copolymer of ethylene, zinc (meth)acrylate and (meth)acrylic acid.

The ternary copolymer of ethylene, zinc (meth)acrylate and (meth)acrylic acid may have a structure in which a zinc ion (Zn²⁺) and a carboxylate anion (—COO—) are ionic bonded. A zinc ion of the ternary copolymer of ethylene, zinc (meth)acrylate and (meth)acrylic acid is a transition metal ion and may be coordinate-bonded to the ester group of the PGA. Accordingly, the ternary copolymer of ethylene, zinc (meth)acrylate and (meth)acrylic acid may be included in the poly(glycolic acid)-containing resin composition to improve durability and melt strength.

In an embodiment, a content of an ethylene monomer based on a total weight of the ternary copolymer of ethylene, zinc (meth)acrylate and (meth)acrylic acid may be in a range from 70 weight percent (wt. %) to 98 wt. %, from 73 wt. % to 95 wt. %, or from 76 wt. % to 92 wt. %.

In an embodiment, a content of a zinc (meth)acrylate monomer based on the total weight of the ternary copolymer of ethylene, zinc (meth)acrylate and (meth)acrylic acid may be in a range from 1 wt. % to 20 wt. %, from 1 wt. % to 17 wt. %, or from 1 wt. % to 14 wt. %.

In an embodiment, a content of a (meth)acrylic acid monomer based on the total weight of the ternary copolymer of ethylene, zinc (meth)acrylate and (meth)acrylic acid may be in a range from 1 wt. % to 29 wt. %, from 4 wt. % to 26 wt. %, or from 7 wt. % to 23 wt. %.

In some embodiments, the ethylene-based ternary copolymer may comprise a copolymer (EAG) of ethylene, glycidyl methacrylate and an alkyl acrylate.

The EAG is an ethylene-based polymer comprising a glycidyl group, and the glycidyl group of the EAG may be included in the poly(glycolic acid)-containing resin composition to be bonded to at least one carboxyl group of the PGA and ZnIO.

Accordingly, the poly(glycolic acid)-containing resin composition may be extended, and the polymer structure may become complex. Accordingly, melt strength and durability of the poly(glycolic acid)-containing resin composition may be improved, and a processibility may be improved.

In an embodiment, a content of an ethylene monomer based on a total weight of the EAG may be in a range from 50 wt. % to 88 wt. %, from 55 wt. % to 82 wt. %, or from 57 wt. % to 78 wt. %.

In an embodiment, a content of a glycidyl methacrylate monomer based on the total weight of the EAG may be in a range from 1 wt. % to 30 wt. %, from 3 wt. % to 25 wt. %, or from 5 wt. % to 20 wt. %.

In an embodiment, a content of an alkyl acrylate monomer based on the total weight of the EAG may be in a range from 10 wt. % to 48 wt. %, from 15 wt. % to 42 wt. %, or from 17 wt. % to 38 wt. %.

In some embodiments, a content of the PGA may be in a range from 60 wt. % to 98 wt. %, from 60 wt. % to 93 wt. %, from 60 wt. % to 88 wt. %, or from 65 wt. % to 85 wt. %, based on a total weight of the poly(glycolic acid)-containing resin composition.

Within the above content range, the PGA may be distributed entirely throughout the poly(glycolic acid)-containing resin composition. Accordingly, the poly(glycolic acid)-containing resin composition may have improved melt strength, durability and processability while maintaining low gas permeability. Additionally, biodegradability of the poly(glycolic acid)-containing resin composition may be improved by the PGA.

In some embodiments, a content of the ZnIO may be in a range from 1 wt. % to 39 wt. %, from 5 wt. % to 38 wt. %, from 7 wt. % to 30 wt. %, or from 8 wt. % to 20 wt. %, based on the total weight of the poly(glycolic acid)-containing resin composition.

Within the above content range, increasing of the gas permeability of the poly(glycolic acid)-containing composition due to an increase of the ZnIO and a decrease of the PGA may be prevented. Additionally, the zinc ions of the ZnIO may be coordinated with the ester group of the PGA to improve durability of the poly(glycolic acid)-containing composition. Further, hygroscopicity of the poly(glycolic acid)-containing resin composition may be reduced, thereby preventing the polymer structure from being collapsed due to high biodegradability of the poly(glycolic acid)-containing resin composition. Thus, structural stability of the poly(glycolic acid)-containing resin composition may be improved.

In some embodiments, a content of the ethylene-based ternary copolymer (e.g., the EAG) may be in a range from 1 wt. % to 39 wt. %, from 2 wt. % to 35 wt. %, from 5 wt. % to 33 wt. %, or from 7 wt. % to 27 wt. % based on the total weight of the poly(glycolic acid)-containing resin composition.

Within the above content range, the ethylene-based ternary copolymer (e.g., the EAG) may be stably cross-linked with the carboxyl group of the PGA and the ZnIO. Thus, melt strength and processability of the poly(glycolic acid)-containing resin composition may be further improved.

In an embodiment, a sum of the content of the ZnIO and the content of the ethylene-based ternary copolymer may be in a range from 2 wt. % to 40 wt. %, from 5 wt. % to 40 wt. %, from 10 wt. % to 35 wt. %, or from 10 wt. % to 30 wt. % based on the total weight of the poly(glycolic acid)-containing resin composition.

Within the above content range, a content of the PGA included in the poly(glycolic acid)-containing resin composition may be 60 wt. % or more, 65 wt. % or more, or 70 wt. % or more. Accordingly, biodegradability of the poly(glycolic acid)-containing resin composition may not be deteriorated, and gas permeability may be reduced and processability may be enhanced.

In some embodiments, the content of the PGA may be greater than the sum of the content of ZnIO and the content of the ethylene-based ternary copolymer. Accordingly, biodegradability, gas barrier properties and durability of the poly(glycolic acid)-containing resin composition may be enhanced.

As described above, the contents of the PGA, the ZnIO and the ethylene-based ternary copolymer included in the poly(glycolic acid)-containing resin composition may be controlled so that a melt viscosity and a melt flow index may be adjusted.

In some embodiments, a combined content of the poly(glycolic acid), the zinc-containing ionomer and the ethylene-based terpolymer is greater 95 wt %, preferably greater 98 wt % and more preferably greater 99 wt % based on a total weight of the poly(glycolic acid)-containing resin composition. The poly(glycolic acid), the zinc-containing ionomer and the ethylene-based terpolymer may also make up for 100 wt % of the poly(glycolic acid)-containing resin composition. In other words, the poly(glycolic acid)-containing resin composition may essentially consist or consist of the poly(glycolic acid), the zinc-containing ionomer and the ethylene-based terpolymer.

In some embodiments, the melt viscosity of the poly(glycolic acid)-containing resin composition may be in a range from 50 Pa·s to 10,000 Pas, from 100 Pa·s to 8,000 Pa·s, or from 200 Pa·s to 6,000 Pa·s.

The melt viscosity may be measured at a strain of 5% and a frequency of 0.1 Hz of a sample prepared by pressing the poly(glycolic acid)-containing resin composition to a thickness of 2 mm at 230° C.

In an embodiment, the melt flow index of the poly(glycolic acid)-containing resin composition may be in a range from 1 g/10 min to 200 g/10 min, from 1 g/10 min to 100 g/10 min, or from 2 g/10 min to 50 g/10 min.

The melt flow index may be measured at a temperature of 230° C. and a load of 2.16 kg according to ASTM D1238.

The melt viscosity and the melt flow index may be maintained within the above range, a flexibility of the poly(glycolic acid)-containing resin composition may be improved compared to that of the PGA. Thus, processability may be improved in a processing such as a foaming-expansion molding, an injection molding, a compression molding, a casting film molding, an inflation film molding, etc. Accordingly, processability from the poly(glycolic acid)-containing resin composition to a film may be improved.

The polyglycolic acid-containing resin composition described herein may be formed by drying and kneading a mixture of the PGA, the ZnIO and the ethylene-based ternary copolymer.

In example embodiments, the PGA, the ZnIO and the ethylene-based ternary copolymer may be introduced into a hopper dryer.

The PGA may be introduced and dried in the hopper dryer maintained at a temperature condition, e.g., ranging from 60° C. to 100° C., from 70° C. to 90° C., or from 75° C. to 85° C. The ZnIO may be introduced and dried in the hopper dryer maintained at a temperature condition, e.g., ranging from 30° C. to 70° C., from 40° C. to 60° C., or from 45° C. to 55° C. The ethylene-based terpolymer (e.g., EAG) may be introduced and dried in the hopper dryer maintained at a temperature conditions, e.g., ranging from 20° C. to 60° C., from 30° C. to 50° C., or from 35° C. to 45° C.

The PGA, the ZnIO and the ethylene-based ternary copolymer may be dried for, e.g., 10 hours to 14 hours, 11 hours to 13 hours, or 11.5 hour to 12.5 hours. In the above range, the PGA, the ZnIO and the ethylene-based ternary copolymer may be sufficiently dried to suppress a side reaction in the kneading process of the PGA, the ZnIO and the ethylene-based ternary copolymer.

The dried PGA, ZnIO and ethylene-based ternary copolymer may be introduced into a chamber of an internal mixer. The chamber of the internal mixer may be maintained at a temperature, e.g., ranging from 220° C. to 260° C., from 225° C. to 250° C., or from 230° C. to 240° C.

When the dried PGA, ZnIO and the ethylene-based ternary copolymer are introduced into the internal mixer, a rotor in the internal mixer may be rotated at a rate, e.g., ranging from 10 rpm to 70 rpm, from 20 rpm to 60 rpm, or from 30 rpm to 50 rpm.

Within the above range, the PGA, the ZnIO and the ethylene-based ternary copolymer may be kneaded without aggregating with each other.

After the introduction of the dried PGA, ZnIO and the ethylene-based ternary copolymer, the kneading may be performed while maintaining the rotor at a rate, e.g., from 60 rpm to 100 rpm, from 70 rpm to 90 rpm, or from 75 rpm to 85 rpm. The kneading may be performed for, e.g., 1 minute to 5 minutes, 2 minutes to 4 minutes, or 2.5 minutes to 3.5 minutes.

In the above range, the PGA, the ZnIO and the ethylene-based ternary copolymer may be uniformly distributed and kneaded.

The kneaded product as described above may be recovered to obtain the poly(glycolic acid)-containing resin composition.

Although the kneading process is described as being performed using the internal mixer, the kneading process is not limited thereto. For example, the dried PGA, the ZnIO and the ethylene-based ternary copolymer may be introduced into a uniaxial extruder or a twin-screw extruder, and then the melt and kneading may be performed. The resin composition discharged through an outlet of the uniaxial extruder or the twin-screw extruder may be cut in a pelletizer to obtain the poly(glycolic acid)-containing resin composition in the form of a pellet.

In some embodiments, a film may be formed from the poly(glycolic acid)-containing resin composition described herein. Accordingly, gas permeability of the film may be reduced, and biodegradability and durability may be improved.

In some embodiments, a thickness of the film may be in a range from 50 μm to 250 μm, from 100 μm to 200 μm, or from 120 μm to 180 μm. In the above range, gas permeability of the film may be sufficiently reduced.

In an embodiment, the film may have an oxygen permeability of 200 g/m²·day or less, 100 g/m²·day or less, or 30 g/m²·day or less. A lower limit of the oxygen permeability of the film is not limited, but, e.g., the film may have the oxygen permeability of 1 g/m²·day or more, 2 g/m²·day or more, 5 g/m²·day or more, or 10 g/m²·day or more.

The oxygen permeability may be measured under a relative humidity of 50% and a temperature of 25° C.

In the above range, blocking properties against a gas (e.g., oxygen) may be improved when using the film as a barrier film, and thus a product may be sufficiently protected by the barrier film.

When the PGA is included in an amount of 60 wt. % or more in the poly(glycolic acid)-containing resin composition, the PGA may be distributed throughout an entire area of the poly(glycolic acid)-containing resin composition. Accordingly, gas barrier properties of the film comprising the poly(glycolic acid)-containing resin composition may be enhanced due to the high gas barrier properties of the PGA.

Thus, the PGA may be included in an amount of 60 wt. % or more in the poly(glycolic acid)-containing resin composition, so that the oxygen permeability of the poly(glycolic acid)-containing resin composition may be lowered. For example, the oxygen permeability of the poly(glycolic acid)-containing resin composition may be lower than an arithmetic mean value of the oxygen permeabilities of the individual polymer components contained in the poly(glycolic acid)-containing resin composition.

In some embodiments, the oxygen permeability of the film may satisfy Formula 1 below.

$$OTR ( PGA - Poly ) < 0.1 ( x \cdot OTR ( PGA ) + ( 1 - x ) \cdot OTR ( Poly ) ) \qquad [ Formula 1 ]$$

In Formula 1, OTR (PGA-Poly) is an oxygen permeability of the film formed from the poly(glycolic acid)-containing resin composition, OTR (PGA) is an oxygen permeability of a film comprising only poly(glycolic acid), OTR (Poly) is an oxygen permeability of a film comprising a resin that comprises only the zinc-containing ionomer or the ethylene-based ternary copolymer, and x is 0.6≤x<1.

The film may be provided as, e.g., a barrier film of packaging materials of various products such as a food packaging material, a battery packaging material, etc.

The above-described film may be prepared from the poly(glycolic acid)-containing resin composition.

In example embodiments, the poly(glycolic acid)-containing resin composition may be pressed by applying a pressure to obtain a film.

In some embodiments, a temperature for the press may be maintained in a range from 200° C. to 260° C., from 210° C. to 250° C., from 220° C. to 240° C., or from 225° C. to 235° C. In this range, the film comprising the poly(glycolic acid)-containing resin composition may be molded and transformed.

In some embodiments, the poly(glycolic acid)-containing resin composition may be pressed at a pressure ranging from 10 MPa to 30 MPa, from 15 MPa to 25 MPa, or from 18 MPa to 22 MPa for 1 minute to 3 minutes or 1.5 minutes to 2.5 minutes.

In the above range, the film may be manufactured to have the above-described thickness. Accordingly, the film having a thin-layered structure may be manufactured while reducing the oxygen permeability.

The formation of the film may include the press as describe above, but the film formation method is not limited thereto. For example, the poly(glycolic acid)-containing resin composition melted in an extruder may be extruded from a t-die to a cooling roll, and then cooled to obtain the film (e.g., a casting method). For example, the poly(glycolic acid)-containing resin composition may be cooled by an air contact through an air ring in a ring-shaped die (e.g., a spiral die, etc.) to obtain the film (e.g., a blowing method).

Hereinafter, experimental examples are provided to help understanding of the present invention, but these embodiments are merely illustrative of the present invention and do not limit the scope of the attached patent claims, and it is obvious to those skilled in the art that various changes and modifications to the embodiments are possible within the scope of the present invention. These modifications are to be interpreted as being within the scope of the attached claims.

### EXAMPLES AND COMPARATIVE EXAMPLES

### Example 1

### (1) Preparation of Raw Materials for Poly(Glycolic Acid)-Containing Resin Composition

A dried PGA was prepared by drying poly(glycolic acid) for 12 hours in a hopper dryer set at 80° C.

A ternary copolymer of ethylene, zinc acrylate and acrylic acid was dried in a hopper dryer set to 50° C. for 12 hours to prepare a ternary copolymer of ethylene, zinc acrylate and acrylic acid. Contents of an ethylene monomer, a zinc acrylate monomer and an acrylic acid monomer in the ternary copolymer of ethylene, zinc acrylate and acrylic acid were about 86.5 wt. %, 6.75 wt. % and 6.75 wt. %, respectively.

A ternary copolymer (EAG) of ethylene, glycidyl methacrylate and methyl acrylate was dried in a hopper dryer set to 40° C. for 12 hours to prepare a dried EAG. Contents of an ethylene monomer, a glycidyl methacrylate monomer, and methyl acrylate monomer of the EAG were 68 wt. %, 8 wt. %, and 24 wt. %, respectively.

A Mitsui hot air dryer was used as the hopper dryer.

### (2) Preparation of the Poly(Glycolic Acid)-Containing Resin Composition

The dried PGA, the dried ternary copolymer of ethylene and zinc acrylate, and the dried EAG were introduced into an internal mixer chamber in a ratio of 80 wt. %, 10 wt. % and 10 wt. %, respectively. A temperature at an inside of the internal mixer chamber was maintained at 230° C., and a rotor of the inner mixer was rotated at a rate of 40 rpm.

Thereafter, the rate of the rotor was increased to 80 rpm and kneading was performed for 3 minutes to prepare a poly(glycolic acid)-containing resin composition as a kneading product. Brabander Majoring Mixer W50 was used as the internal mixer.

### (3) Film Formation

The poly(glycolic acid)-containing resin composition was pressurized at a pressure of 20 MPa for 2 minutes using a press set to 230° C. to prepare a film.

### Examples 2 to 7 and Comparative Examples 1 to 6

Poly(glycolic acid)-containing resin compositions and films of Examples 2 to 7 and Comparative Examples 1 to 6 were prepared by the same methods as those in Example 1, except that type of the PGA and a weight ratio of the dried PGA, the dried ternary copolymer of ethylene, zinc acrylate and acrylic acid, and the dried EAG were adjusted, as shown in Table 1 below.

TABLE 1

| | | | terpolymer of | |
|---|---|---|---|---|
| | PGA | | ethylene, zinc acrylate | |
| | | content | and acrylic acid | EAG |
| | Type | (wt. %) | (wt. %) | (wt. %) |
| Example 1 | A | 80 | 10 | 10 |
| Example 2 | A | 70 | 10 | 20 |
| Example 3 | A | 70 | 20 | 10 |
| Example 4 | A | 60 | 30 | 10 |
| Example 5 | A | 60 | 20 | 20 |
| Example 6 | A | 50 | 30 | 20 |
| Example 7 | B | 80 | 5 | 15 |
| Comparative | A | 100 | 0 | 0 |
| Example 1 | | | | |
| Comparative | A | 0 | 100 | 0 |
| Example 2 | | | | |
| Comparative | A | 0 | 0 | 100 |
| Example 3 | | | | |
| Comparative | A | 0 | 50 | 50 |
| Example 4 | | | | |
| Comparative | A | 50 | 50 | 0 |
| Example 5 | | | | |
| Comparative | B | 100 | 0 | 0 |
| Example 6 | | | | |

The types of PGA listed in Table 1 are as follows:

A: Poly(glycolic acid) having a number average molecular weight (Mn) of 35,000 to 45,000, and a weight average molecular weight (Mw) of 80,000 to 95,000 as measured by Gel Permeation Chromatography (GPC).

B: Poly(glycolic acid) having a number average molecular weight (Mn) of 70,000 to 80,000 and a weight average molecular weight (Mw) of 160,000 to 180,000 as measured by GPC.

The gel permeation chromatography was performed by dissolving poly(glycolic acid) in hexafluoro isopropyl alcohol (HFIP), filtering the solution with a polytetrafluoroethylene (PTFE) filter and injecting the solution into a Tosoh EcoSEC HLC-8320 GPC. Poly(methyl methacrylate, PMMA) was used as a standard material.

### Experimental Example 1

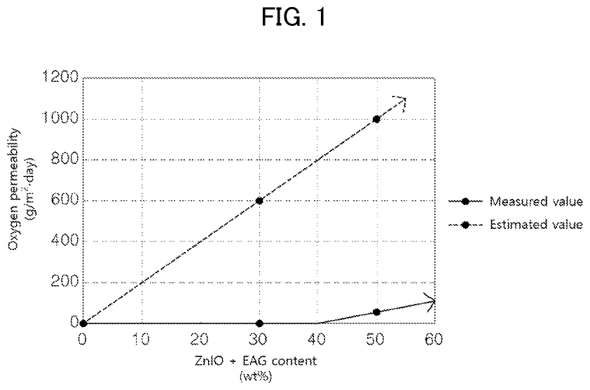

FIG. 1 is a graph showing measured and estimated values of an oxygen permeability of a film according to a sum of the content of the ternary copolymer of ethylene, zinc acrylate and acrylic acid and the content of the EAG contained in the poly(glycolic acid)-containing resin composition.

The estimated value of the oxygen permeability represents an arithmetic average of the oxygen permeability of the PGA, the oxygen permeability of the ternary copolymer of ethylene, zinc acrylate and acrylic acid and the oxygen permeability of the EAG included in the poly(glycolic acid)-containing resin composition according to the weight ratios thereof.

The measured value of the oxygen permeability represents a measured value of the oxygen permeability of the film comprising the poly(glycolic acid)-containing resin composition. Specifically, the measured values of the oxygen permeability of the film of Example 1, Example 2, Example 5 and Example 6 are provided.

Referring to FIG. 1, the estimated value of the oxygen permeability of the film was calculated as being linearly increased according to the sum of the content of the ternary copolymer of ethylene, zinc acrylate and acrylic acid, and the content of EAG.

However, when the sum of the content of the ternary copolymer of ethylene, zinc acrylate and acrylic acid, and the content of the EAG was 40 wt. % or less (i.e., the content of the PGA was more than 60 wt. %), the oxygen permeability was low. Additionally, when the sum of the ternary copolymer content of ethylene, zinc acrylate, and acrylic acid and the content of the EAG exceeded 40 wt. %, the measured oxygen permeability was increased in proportion to the content.

### Experimental Example 2

### (1) Measurement of Melt Viscosity

The poly(glycolic acid)-containing resin composition prepared according to each of Examples and Comparative Examples was pressed to a thickness of 2 mm at a temperature of 230° C., and then a melt viscosity was measured using a viscosity measuring apparatus (TAARES).

The viscosity measuring apparatus was set under conditions of 230° C., 5% strain and a frequency of 0.1 Hz to 400 Hz, and a viscosity value measured at a frequency of 0.1 Hz was designated as a melt viscosity.

### (2) Measurement of Melt Flow Index

A melt flow index of each poly(glycolic acid)-containing resin composition prepared according to the above-described Examples and Comparative Examples was measured at a temperature of 230° C. and a load of 2.16 kg according to ASTM D1238.

### (3) Measurement of Oxygen Permeability

Each film according to the above-described Examples and Comparative Examples was mounted on an oxygen permeability measuring apparatus (MOCON OX TRANS model 2/61) to measure an oxygen permeability.

The oxygen permeability was measured at a relative humidity of 50% and a temperature of 25° C. for 12 hours, and a value at a point where the permeability was stabilized was designated as the oxygen permeability.

A measurable upper limit of the oxygen permeability was 1,200 g/m²·day, and the oxygen permeability of the film which could not be measured beyond the upper limit was marked as ‘excess’.

The evaluation results are shown in Table 2 below.

TABLE 2

| | melt | melt flow | | |
|---|---|---|---|---|
| | viscosity | index | oxygen permeability | |
| | (Pa · s) | (g/10 min) | g/m² · day | g · μm/m² · day |
| Example 1 | 213.3 | 134.9 | 0.4 | 110 |
| Example 2 | 658.7 | 65.4 | 0.5 | 130 |
| Example 3 | 521.9 | 123.5 | 0.5 | 120 |
| Example 4 | 1196.9 | 86.3 | 25 | 5600 |
| Example 5 | 957.2 | 57.4 | 40 | 9000 |
| Example 6 | 1729.9 | 47.8 | 150 | 33800 |
| Example 7 | 6272.6 | 4.5 | 0.4 | 64.2 |
| Comparative | 24.8 | 300 | 0.2 | 40 |
| Example 1 | | | | |
| Comparative | 3796.7 | 5.7 | excess | excess |
| Example 2 | | | | |
| Comparative | 1732.9 | 11.5 | excess | excess |
| Example 3 | | | | |
| Comparative | — | 1.2 | excess | excess |
| Example 4 | | | | |
| Comparative | 2694.6 | 71.3 | 70 | 15400 |
| Example 5 | | | | |
| Comparative | 243.4 | 12.5 | 0.4 | 65.6 |
| Example 6 | | | | |

Referring to Table 2, the films according to Examples provided the oxygen permeability of 200 g/m²·day or less.

In Examples 4 and 5, where the content of the PGA was reduced to 60 wt. %, the oxygen permeability was relatively increased.

In Example 6, in which the content of the PGA was less than 60 wt. %, the oxygen permeability was relatively increased.

In Example 7, where the molecular weight of the PGA was increased, the melt viscosity was relatively increased and the melt flow index was relatively decreased.

In Comparative Example 1, using only the PGA, the melt viscosity of the poly(glycolic acid)-containing resin composition was decreased and the melt flow index was increased.

In Comparative Example 2, using only the ternary copolymer of ethylene, zinc acrylate and acrylic acid, the oxygen permeability was greater than 1,200 g/m²·day.

In Comparative Example 3, using only the EAG, the oxygen permeability was greater than 1,200 g/m²·day.

In Comparative Example 4, where the copolymer of ethylene and zinc acrylate and the EAG were kneaded without using the PGA, the oxygen permeability exceeded 1,200 g/m²·day.

What is claimed is:

1. A poly(glycolic acid)-containing resin composition, comprising:
a poly(glycolic acid);
a zinc-containing ionomer; and
an ethylene-based terpolymer.

2. The poly(glycolic acid)-containing resin composition of claim 1, wherein the zinc-containing ionomer comprises a terpolymer of ethylene, zinc (meth)acrylate and (meth)acrylic acid.

3. The poly(glycolic acid)-containing resin composition of claim 1, wherein the ethylene-based terpolymer comprises a copolymer of ethylene, glycidyl methacrylate and an alkyl acrylate.

4. The poly(glycolic acid)-containing resin composition of claim 1, wherein a content of the poly(glycolic acid) is in a range from 60 wt. % to 98 wt. %, based on a total weight of the poly(glycolic acid)-containing resin composition.

5. The poly(glycolic acid)-containing resin composition of claim 1, wherein a content of the zinc-containing ionomer is in a range from 1 wt. % to 39 wt. %, based on a total weight of the poly(glycolic acid)-containing resin composition.

6. The poly(glycolic acid)-containing resin composition of claim 1, wherein a content of the ethylene-based terpolymer is in a range from 1 wt. % to 39 wt. %, based on a total weight of the poly(glycolic acid)-containing resin composition.

7. The poly(glycolic acid)-containing resin composition of claim 1, wherein a sum of a content of the zinc-containing ionomer and a content of the ethylene-based terpolymer is in a range from 2 wt. % to 40 wt. %, based on a total weight of the poly(glycolic acid)-containing resin composition.

8. The poly(glycolic acid)-containing resin composition of claim 1, wherein a content of the poly(glycolic acid) is greater than a sum of a content of the zinc-containing ionomer and a content of the ethylene-based terpolymer, based on a total weight of the poly(glycolic acid)-containing resin composition.

9. The poly(glycolic acid)-containing resin composition of claim 1, wherein the poly(glycolic acid)-containing resin composition has a melt viscosity of 200 Pa's to 10,000 Pa's measured under conditions of 230° C., a 5% strain and a frequency of 0.1 Hz.

10. The poly(glycolic acid)-containing resin composition of claim 1, wherein the poly(glycolic acid)-containing resin composition has a melt flow index of 1 g/10 min to 200 g/10 min measured at 230° C. and a load of 2.16 kg.

11. A film formed from the poly(glycolic acid)-containing resin composition of claim 1.

12. The film of claim 11, wherein a thickness of the film is in a range from of 50 μm to 250 μm.

13. The film of claim 12, wherein an oxygen permeability measured at a relative humidity of 50% and 25° C. of the film is 200 g/m²·day or less.

14. The film of claim 11, wherein an oxygen permeability of the film satisfies Formula 1:
$$OTR ( PGA - Poly ) < 0.1 ( x \cdot OTR ( PGA ) + ( 1 - x ) \cdot OTR ( Poly ) ) \qquad [ Formula 1 ]$$
wherein, in Formula 1, OTR (PGA-Poly) is an oxygen permeability of the film formed from the poly(glycolic acid)-containing resin composition, OTR (PGA) is an oxygen permeability of a film comprising only poly(glycolic acid), OTR (Poly) is an oxygen permeability of a film comprising a resin that comprises only the zinc-containing ionomer or the ethylene-based ternary copolymer, and x is 0.6≤x<1.
